(19) United States
(12) Patent Application Publication
(10) Pub. No.: US 2023/0263175 A1
(43) Pub. Date: Aug. 24, 2023

(54) A SYSTEM AND A METHOD FOR AUTOMATICALLY PLACING ICE INTO BOXES HAVING TWO OR MORE DIFFERENT WIDTHS

(71) Applicant: MAREL ICELAND EHF., Gardabaer (IS)

(72) Inventors: Thorir FINNSSON, Gardabaer (IS); Jón Vidar SIGURGEIRSSON, Gardabaer (IS)

(21) Appl. No.: 18/014,425

(22) PCT Filed: Jul. 1, 2021
(86) PCT No.: PCT/EP2021/068221

§ 371 Date: Jan. 4, 2023

(30) Foreign Application Priority Data
Jul. 6, 2020 (DK) PA 2020 70462

(51) Int. Cl. A23B 4/06; F25D 3/06; F25C 5/20; B65B 25/06; A23L 3/36; B65B 1/32; B65B 59/00

(52) U.S. Cl. CPC A23B 4/062; F25D 3/06; F25C 5/20; B65B 25/062; A23L 3/361; B65B 1/32; B65B 59/001

(57) ABSTRACT

A system for placing ice into boxes containing food products and the system includes: a control unit, an ice in-feed device, an ice distribution device configured for receiving ice from the ice in-feed device and for distributing the received ice into the open upper side of the boxes while the boxes pass the ice distribution device. The ice distribution device has an ice width adjuster device for interacting with the received ice prior to distributing the received ice into the open upper side of the boxes while the boxes pass the ice distribution device. The ice width adjuster device is controlled by the control unit using at least one characteristic parameter relating to the boxes including the width of the boxes as a control command in adjusting the width of the width adjuster device.

### FIELD OF THE INVENTION

The present invention relates to a system for placing ice into boxes containing food products while the boxes are conveyed by a conveyor device.

### BACKGROUND OF THE INVENTION

In order to enhance freshness of portions fresh food products such as fish or fish fillets in boxes, it is desirable to reserve some volume in the boxes for ice to remain the freshness of the fish as high as possible.

Today, it is common that the boxes are manually filled with ice. This obviously results in that too much amount of ice is used resulting in unnecessary ice usage. Also, the weight of the boxes is too high which will result in increase in transport costs.

### SUMMARY OF THE INVENTION

On the above background it is an object of embodiments of the present invention to provide a system capable of automatically distributing ice evenly into boxes containing food products and that is further capable of adapting the ice distribution to different shapes/sizes of boxes containing food products therein.

In general, the invention preferably seeks to mitigate, alleviate or eliminate one or more of the above-mentioned disadvantages of the prior art singly or in any combination. In particular, it may be seen as an object of embodiments of the present invention to provide a system that solves the above-mentioned problems, or other problems.

To better address one or more of these concerns, in a first aspect of the invention, a system is provided for placing ice into boxes containing food products while the boxes are conveyed by a box-conveyor device, where the boxes have an open upper side and two or more different widths extending across the conveying direction of the boxes, comprising:

a control unit,
an ice in-feed device,
an ice distribution device configured for receiving ice from the ice in-feed device and for distributing (or distribute) the received ice into the open upper side of the boxes while the boxes pass the ice distribution device,
wherein the ice distribution device further comprises an ice width adjuster device for interacting with the received ice prior to distributing the received ice into the open upper side of the boxes while the boxes pass the ice distribution device, where the ice width adjuster device (or ice width adjuster) is controlled by the control unit using at least one characteristic parameter relating to the boxes including the width of the boxes as a control command in adjusting the width of the width adjuster device such that the width of the distributed ice in the boxes is essentially the same as the width of the incoming boxes, such as the width of the incoming boxes being the width within the incoming boxes (or the inner width of the incoming boxes).

Accordingly, it is possible to in an automatic way evenly distribute ice into boxes, and automatically adapt the ice distribution in the boxes to different types having different widths. It is thus ensured that all the distributed ice enters the boxes and thus no waste of ice outside of the boxes. The at least one characteristic parameter relating to the boxes may be information obtained on an upstream side, e.g. where the food products are placed into the boxes, where this information is associated to the boxes be e.g. means by tracing or tracking the boxes until they reach the ice distribution device.

By ‘where the boxes have an open upper side and two or more different widths’ may be understood that the boxes have (two or more) different widths with respect to or amongst each other, such as encompassing that each box has one or more widths and another box within the boxes has one or more other widths.

By ‘the incoming boxes’ may be understood ‘the boxes’, such as in each case the box that is filled or going to be filled.

In one embodiment, the ice distribution device comprises a conveyor device, such as an ice-conveyor device, having an endless belt and position below the ice in-feed device and above the box-conveyor device, where the received ice is received on an upper side of the endless belt, where the control unit is further configured to operate the advancement of the endless belt of the conveyor device, such as the ice-conveyor device, when distributing ice into the open upper side of the boxes. The control unit may be configured to operate the advancement based on the at least one characteristics of the incoming boxes, e.g. simply the timing when the position of the boxes is detected and subsequently track the position of the boxes until the distribution takes place, or the control unit may be coupled to a sensing means such as a positioning sensor placed on a downstream side relative to the detection device, which may trigger the advancement of the endless belt when the box is at the right position, i.e. below the ice distribution device.

In one embodiment, the at least one characteristic parameter relating to the boxes further includes the length of the boxes, where the length is utilized by the control unit as a control parameter in controlling the advancing speed of the endless belt of the conveyor device, such as the ice-conveyor device, while the boxes pass the ice distribution device, e.g. such that the speed is increased temporarily for shorter boxes compared to longer boxes. Results show that when releasing the ice onto the upper side of the endless conveyor belt, such as the ice-conveyor device, the ice becomes distributed over similar length on the endless conveyor belt, such as the ice-conveyor device, although the amount of ice may differ, e.g. 1 kg vs. 1.5 kg. Therefore, the fact that a shorter box takes less time to pass the ice distribution device (can be taken into account and) it is (or can be) ensured that all the ice on the upper side of the endless belt will be distributed evenly between the opposite ends of the shorter box, whereas (the fact that a larger box takes more time to pass the ice distribution device can be taken into account since) for larger boxes by having less advancing speed on the endless conveyor belt, such as the ice-conveyor device, it is ensured that all the ice will be distributed evenly between the opposite ends of the box.

In one embodiment, the system further comprises a front plate member placed in front of a downstream end of the conveyor device, such as the ice-conveyor device, such that it extends below the upper side of the endless belt, wherein the front plate member has an associated controllable bottom structure controlled by the control unit, where the controlling includes moving the associated bottom structure from a closing position where the front plate member and the bottom structure act as a buffer capable of accumulating ice therein from the downstream end of the conveyor device, such as the ice-conveyor device, to an open second position where the accumulated ice and ice from the downstream end of the conveyor device, such as the ice-conveyor device, is released into the open upper side of the boxes as they pass the ice distribution device. The buffer ensures that after filling a box that all remaining ice is accumulated therein after stopping the endless belt (since now, no box is present). Also, when distributing ice into a subsequent box, an initial buffer amount ensures a necessary immediate amount of ice when starting the ice distribution.

In one embodiment, the ice in-feed device comprises an ice-portioning device configured to supply portions of ice to the ice distribution device. In a preferred embodiment, the portions of ice are determined based on the at least one identified characteristic. Accordingly, the system acts as an icedoser system where it is now possible to accurately determine the ice needed in the boxes to retain the freshness and quality in the most optimal manner, e.g. larger boxes require more ice compared to smaller boxes. Also, the total weight of boxes is reduced since now only the necessary amount of ice is distributed into the boxes, which will result in less waste of ice and lower transportation costs.

In one embodiment, the ice-portioning device comprises at least one weighing hopper configured to receive and accumulate ice until a pre-defined target weight is accumulated, where the pre-defined target weight is e.g. dependent on the at least one characteristics of the incoming boxes. In a preferred embodiment, the at least one weighing hopper includes two or more weighing hoppers, and where supplying portions of ice to the ice distribution device comprises releasing ice from one hopper at a time, or by two or more hoppers at a time. As an example, the at least one characteristic could additionally be the length of the boxes, and based thereon, larger boxes may require more ice. Accordingly, for larger boxes, e.g. larger width and length, an amount of e.g. 1.5 kg ice may be accumulated in the boxes on top of the food products, compared to boxes with less width and length, where e.g. 1.0 kg of ice is accumulated and distributed on top of the food products. Another characteristic might also be the weight of the food objects in the boxes which may be based on an estimate from the image data from the detection device or based on previous weight determination of the food objects in the boxes.

In an embodiment, the ice width adjuster device comprises adjustable guiding structures having downstream ends, and where adjusting the width includes adjusting the distance between the downstream ends of the guiding structure. The adjustable guiding structures may as an example be arranged in a plane parallel to the upper side of the conveyor device, such as the ice- conveyor device, such that prior to releasing ice into the open upper side of the boxes the width of the released ice has been adapted to the inner width of the boxes.

In an embodiment, the adjustable guiding structures comprise a pair of adjustable flaps having free ends moveable relative to each other from a first position defining first width to at least one second position defining at least one second width, where the pair of flaps is positioned below a downstream end of the ice distribution device.

In one embodiment, the ice in-feed device comprises:

an ice compartment having an open upper end for receiving ice from an ice source and an open lower end, and
an ice-infeed conveyor positioned below the lower end of the ice compartment having an infeed end and controlled by the control unit.

In one embodiment, the system, such as the icedoser machine, further comprises a detection device for identifying at least one characteristic parameter relating to the boxes.

The detection device may as an example be a scanner that reads marks on the boxes e.g. via any type of physical label on the boxes, e.g. ice dosing requirements on each box, width of the boxes etc. The detection device should of course not be construed as being limited to be a scanner, but it might just as well include a camera that is capable of detecting the width, and preferably the length of the boxes.

In a second aspect of the invention, a method is provided for automatically placing ice into boxes containing food products while the boxes are conveyed by a box conveyor device, where the boxes have an open upper side and two or more different widths extending across the conveying direction of the boxes, comprising:

feeding ice from an ice in-feed device onto an ice distribution device where the feeding is controlled by a control unit using at least one characteristic parameter relating to the boxes including the width of the boxes as a control command, where the ice is distributed evenly by the ice distribution device into the open upper side of the boxes while the boxes pass the ice distribution device,
wherein the method further comprises automatically adjusting the width of the distributed ice into the open upper side of the boxes based on the at least one characteristic parameter relating to the boxes such that the width of the distributed ice in the boxes is essentially the same as the width of the incoming boxes, such as the width of the incoming boxes being the width within the incoming boxes (or the inner width of the boxes).

The food may include any food products where it is essential to cool the food products down to an optimal temperature, such as fish products such as whole fish, fish fillet, fish pieces.

The at least one characteristic parameter may be selected from, but is not limited to, the width of the boxes, the length, the height of the boxes, the type of food products and/or the weight of the food products in the boxes, and combination of two or more of the above parameters.

The weight of the distributed ice into the boxes is controlled based on the identified characteristics such that it is (approximately) at or below, such as immediately below, a pre-defined target level, so as to minimize the waste of ice. The identified characteristics further include the length of the boxes, and/or the height of the boxes, and/or the available volume within the boxes.

In general, the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIGS. 1 to 3 show a perspective view, a side view and a top view of a system according to the present invention,

FIGS. 4 and 5 show a simplified view of FIGS. 1 to 3, such as of a system as depicted in FIGS. 1 to 3,

FIGS. 6 to 9 show a further detailed view of the FIGS. 4 and 5, such as of a system as depicted in FIGS. 4 and 5.

### DESCRIPTION OF EMBODIMENTS

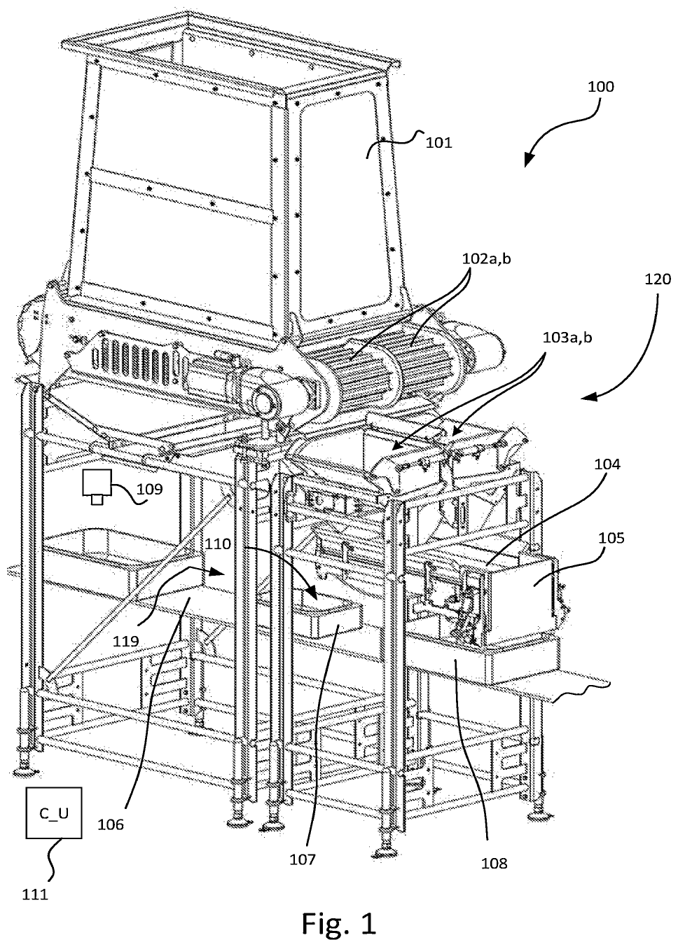

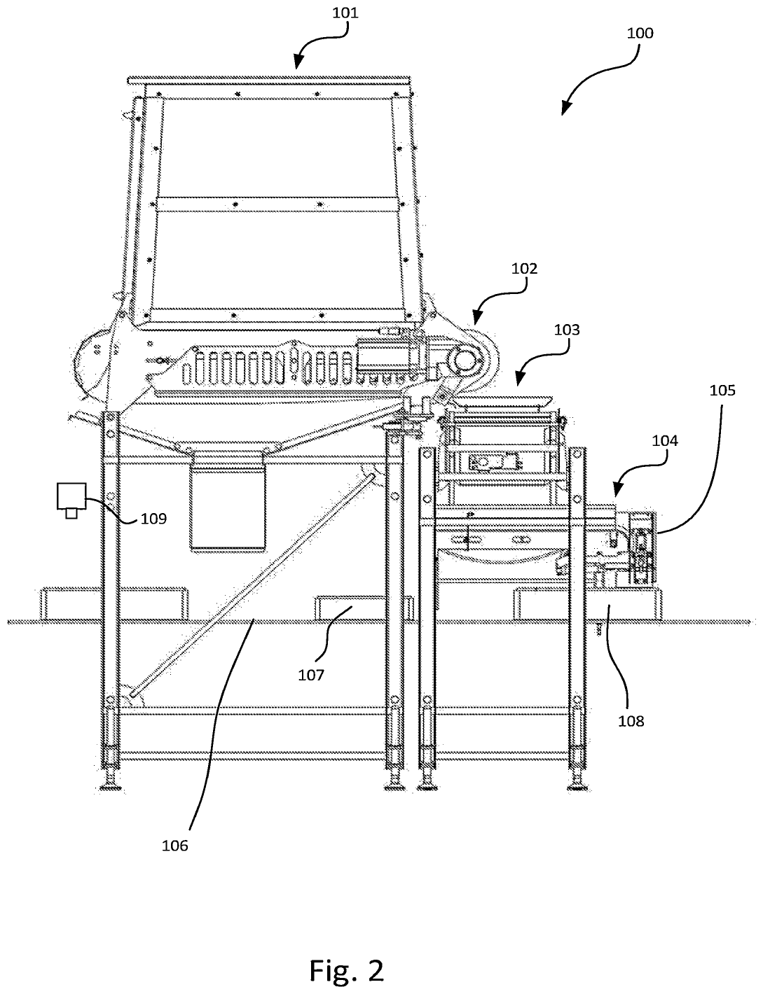

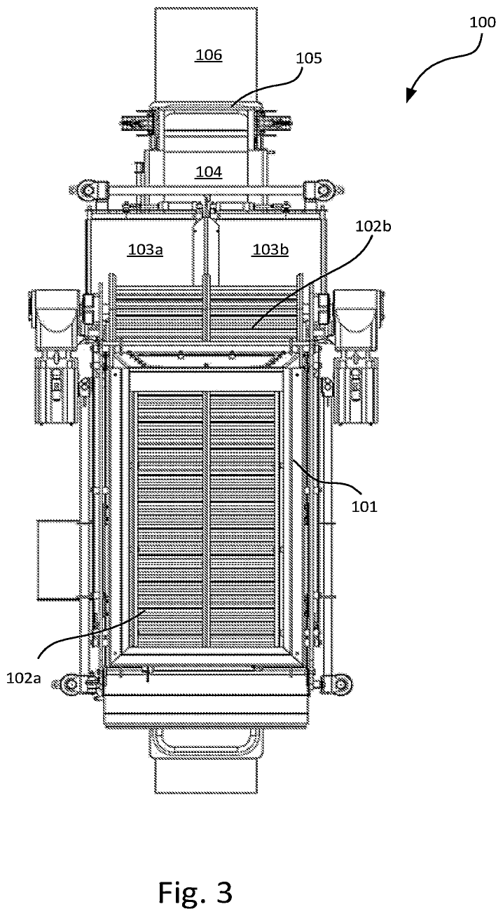

FIGS. 1 to 3 show a perspective view, a side view and a top view of a system 100 according to the present invention configured to place ice into boxes 107, 108 containing food products while the boxes are conveyed by a box conveyor device 106 in a direction indicated by arrow 119, where the boxes have an open upper side 110 and two or more different widths 107 extending across the conveying direction of the boxes, where the system in this embodiment comprises a detection device 109, a control unit 111, an ice in-feed device 120, and an ice distribution device 104.

The detection device 109 is controlled by the control unit 111 and is configured to identify at least one characteristics of the incoming boxes including the width of the incoming boxes, such as the width of the incoming boxes being the width within the incoming boxes (or the inner width of the boxes). Other characteristics might also include the length of the boxes, or available volume in the boxes, the amount of food products.

The ice in-feed device 120 is configured to deliver ice to the ice distribution device 104, and the ice distribution device is configured to distribute the received ice into the open upper side 110 of the boxes while the boxes pass the ice distribution device below it.

The ice in-feed device 120 shown here comprises an ice-portioning device comprising two side-by-side arranged weighing hoppers 103a, b configured to receive and accumulate ice until a pre-defined target weight is accumulated therein, where the pre-defined target weight is e.g. dependent on the at least one characteristics of the incoming boxes, size and/or shape or the width. In a preferred embodiment, the two weighing hoppers supply portions of ice to the ice distribution device by means of releasing ice from one hopper at a time, in that way the throughput of releasing portions of ice is enhanced, i.e. while one hopper releases ice the other one accumulates ice, and vice versa.

The ice in-feed device 120 further comprises an ice compartment 101 having an open upper end for receiving ice from an ice source and an open lower end, and an ice-infeed conveyor 102 positioned below the lower end of the ice compartment having an infeed end and controlled by the control unit. In the embodiment shown here, the conveyor 102 comprises two lanes of endless belts 102a,b having upwardly extending protrusions extending across the width of the conveyor for facilitating accumulating ice on the endless belts 102a,b. The control unit controls the advancement of the conveyor 102 by e.g. starting/stopping it and thus feeds ice in discrete steps ice into the respective hoppers 103a,b, preferably based on the position of incoming boxes and the characteristics of the incoming boxes, e.g. the size/shapes of the boxes.

As shown in this embodiment, the ice distribution device 104 comprises a conveyor device, such as an ice-conveyor device, having an endless belt and position below the ice in-feed device 103a,b and above the box-conveyor device 106, where the received ice is received on an upper side of the endless belt, where the control unit 111 is further configured to operate the advancement of the endless belt of the conveyor device, such as the ice-conveyor device, when distributing ice into the open upper side of the boxes while the boxes pass the ice distribution device 104.

In one embodiment, the at least one identified characteristics of the incoming boxes further includes the length of the boxes, where the length is utilized by the control unit as a control parameter in controlling the advancing speed of the endless belt of the conveyor device 104, such as the ice-conveyor device, of the ice distribution device while the boxes pass the ice distribution device, e.g. such that the speed is increased temporarily for shorter boxes compared to longer boxes. It is namely so the whether there is a difference in ice weights in the weighing hoppers 103a,b, e.g. 1 kg vs 1,5 kg, that the distribution of the ice when released onto the endless belt of the ice distribution device is similar. This means that for boxes having shorter lengths, that the speed of the advancing speed of the endless belt of the conveyor device 104, such as the ice-conveyor device, must be larger compared for longer boxes.

This embodiment further shows front plate member 105 placed in front of a downstream end of the conveyor device, such as the ice-conveyor device, such that it extends below the upper side of the endless belt, wherein the front plate member 105 has an associated controllable bottom structure (not shown) controlled by the control unit 111, where the controlling includes moving the associated bottom structure from a closing position where the front plate member and the bottom structure act as a buffer capable of accumulating ice therein from the downstream end of the conveyor device, such as the ice-conveyor device, to an open second position where the accumulated ice and ice from the downstream end of the conveyor device, such as the ice-conveyor device, is released into the open upper side of the boxes as they pass the ice distribution device.

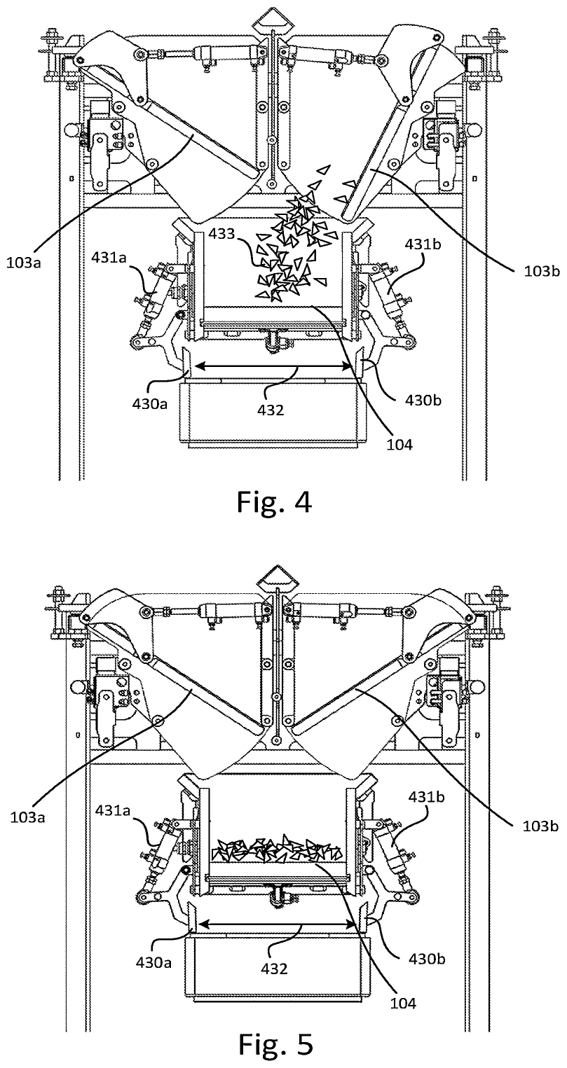

FIGS. 4 and 5 show a simplified view of FIGS. 1 to 3, showing the weighing hoppers in two different positions, where in FIG. 4 weighing hopper 103b is in an open position where ice 433 is being released onto the ice distribution device/conveyor 104, such as the ice-conveyor device, and FIG. 5 shows where both the weighing hoppers 103a,b are in a closing position.

Shown is also an ice width adjuster device 430, 431 controlled by the control unit 111 for interacting with the received ice 433 prior to distributing the received ice portions into the open upper side of the boxes while the boxes pass the ice distribution device and before the ice enters the open upper side of the boxes. As shown here, the ice width adjuster device 430, 431 comprises adjustable pair of adjustable flaps 430a,b moveable by driving arms 431a,b which may be e.g. hydraulic or electric driven. The position shown here is an open position, i.e. the largest width opening, which would be the position when box having larger width is passing the ice distribution device.

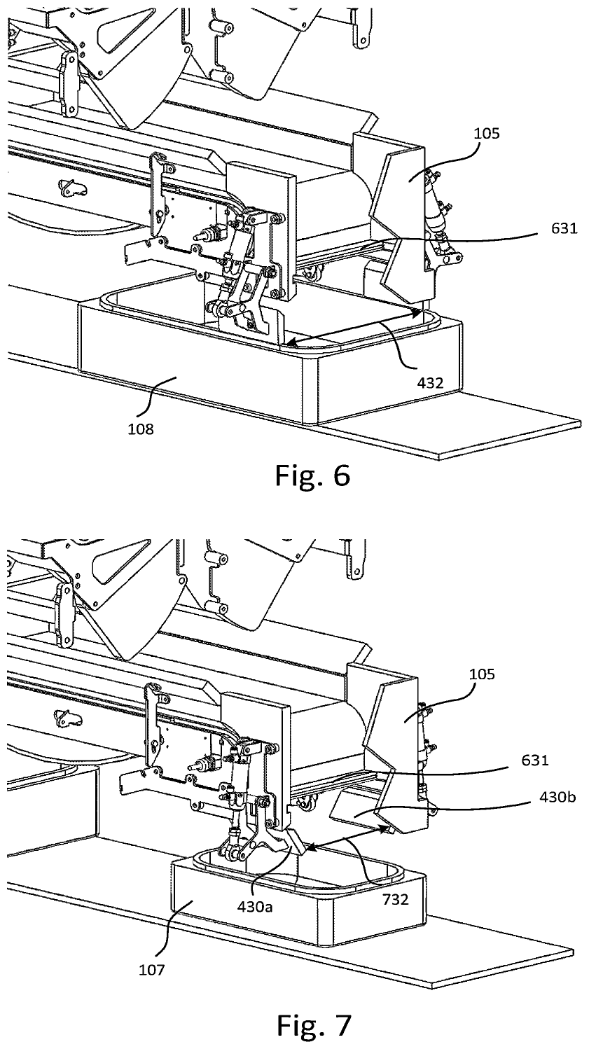

FIGS. 6 and 7 show a simplified view of the operation of the adjustable flaps 430a,b (front plate member 105 is partly removed to illustrate the functioning of the adjustable flaps), where the width 432 between the free ends of the adjustable flaps corresponds to the inner width of the box 108, and where this width is maintained while the box 108 passes the ice distribution device. As depicted here, the adjustable flaps are positioned below a downstream end of the ice distribution device 104. Shown is also the bottom structure 631 discussed in relation to FIGS. 1 to 3, where the bottom structure is in an open position so as to allow the ice to be released there through and into box 108.

FIG. 7 shows at a later time point where box 107 that has less width than box 108 discussed in relation to FIG. 6 has entered the zone of the ice distribution device 104 where the adjustable flaps 430a,b automatically move such that their free ends are closer to each other meaning that the ice distribution into the box 107 will be narrower and in line with the internal width of the box 107.

As will be discussed in more details in relation to FIGS. 4 to 7, the ice distribution device further comprises an ice width adjuster device controlled by the control unit 111 for interacting with the received ice prior to distributing the received ice portions into the open upper side of the boxes while the boxes pass the ice distribution device by means of utilizing the identified width of the boxes as a control command in adjusting the width of the width adjuster device such that the width of the distributed ice in the boxes is essentially the same as the width of the incoming boxes, such as the width of the incoming boxes being the width within the incoming boxes (or the inner width of the boxes).

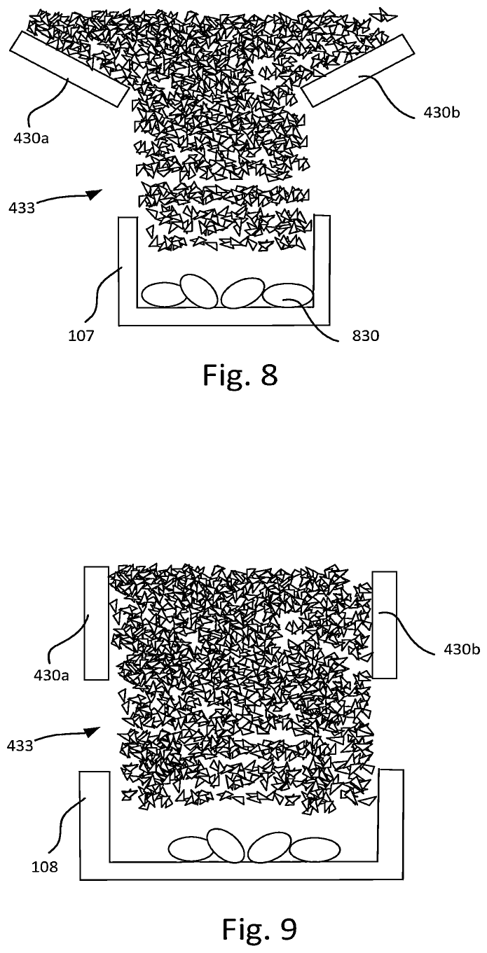

FIGS. 8-9 illustrate graphically the scenarios where the ice width adjuster device in two different positions, where the adjustable flaps 430a,b are in FIG. 8 shown in a position essentially corresponding to the inner width of the box 107 containing food products such that the released ice 433 is adapted to the inner width of the box 107, and where the box 108 shown in FIG. 9 having larger width, the adjustable flaps 430a,b are adjusted to that width such that the released ice 433 is adapted to the inner width of the box 108.

### EMBODIMENTS OF THE INVENTION OR ALTERNATIVE EXAMPLES OR EMBODIMENTS

1. A system for placing ice (433) into boxes (107, 108) containing food products while the boxes are conveyed by a box conveyor device, where the boxes have an open upper side and two or more different widths extending across the conveying direction of the boxes, comprising:

a control unit (111),
an ice in-feed device (120),
an ice distribution device (104) configured for receiving ice from the ice in-feed device and distribute the received ice into the open upper side of the boxes while the boxes pass the ice distribution device,
wherein the ice distribution device further comprises an ice width adjuster device for interacting with the received ice prior to distributing the received ice into the open upper side of the boxes while the boxes pass the ice distribution device, where the ice width adjuster is controlled by the control unit using at least one characteristic parameter relating to the boxes including the width of the boxes as a control command in adjusting the width of the width adjuster device such that the width of the distributed ice in the boxes is essentially the same as the width within the incoming boxes.

2. The system according to embodiment 1, wherein the ice distribution device comprises a conveyor device having an endless belt and position below the ice in-feed device and above the box-conveyor device, where the received ice is received on an upper side of the endless belt, where the control unit is further configured to operate the advancement of the endless belt of the conveyor device when distributing ice into the open upper side of the boxes.

3. The system according to embodiment 2, wherein the at least one characteristic parameter relating to the boxes further includes the length of the boxes, where the length is utilized by the control unit as a control parameter in controlling the advancing speed of the endless belt of the conveyor device while the boxes pass the ice distribution device, e.g. such that the speed is increased temporarily for shorter boxes compared to longer boxes.

4. The system according to embodiment 2 or 3, further comprising a front plate member placed in front of a downstream end of the conveyor device such that it extends below the upper side of the endless belt, wherein the front plate member has an associated controllable bottom structure controlled by the control unit, where the controlling includes moving the associated bottom structure from a closing position where the front plate member and the bottom structure act as a buffer capable of accumulating ice therein from the downstream end of the conveyor device, to an open second position where the accumulated ice and ice from the downstream end of the conveyor device is released into the open upper side of the boxes as they pass the ice distribution device.

5. The system according to any of the preceding embodiments, wherein the ice in-feed device comprises an ice-portioning device configured to supply portions of ice to the ice distribution device.

6. The system according to any of the preceding embodiments, wherein the portions of ice are determined based on the at least one identified characteristic.

7. The system according to embodiments 5 or 6, wherein the ice-portioning device comprises at least one weighing hopper configured to receive and accumulate ice until a pre-defined target weight is accumulated, where the pre-defined target weight is e.g. dependent on the at least one characteristics of the incoming boxes.

8. The system according to embodiment 7, wherein the at least one weighing hopper includes two or more weighing hoppers, and where supplying portions of ice to the ice distribution device comprises releasing ice from one hopper at a time, or by two or more hoppers at a time.

9. The system according to any of the preceding embodiments, wherein the ice width adjuster device comprises adjustable guiding structures having downstream ends, and where adjusting the width includes adjusting the distance between the downstream ends of the guiding structure.

10. The system according to any of the embodiments 1 to 8, wherein the adjustable guiding structures comprise a pair of adjustable flaps having free ends moveable relative to each other from a first position defining first width to at least one second position defining at least one second width, where the pair of flaps is positioned below a downstream end of the ice distribution device.

11. The system according to any of the preceding embodiments, wherein the ice in-feed device comprises:

an ice compartment having an open upper end for receiving ice from an ice source and an open lower end, and
an ice-infeed conveyor positioned below the lower end of the ice compartment having an infeed end and controlled by the control unit.

12. The system according to any of the preceding embodiments, further comprising a detection device (109) for identifying at least one characteristic parameter relating to the boxes.

13. A method of automatically placing ice into boxes (107, 108) containing food products while the boxes are conveyed by a box conveyor device, where the boxes have an open upper side and two or more different widths extending across the conveying direction of the boxes, comprising:

feeding ice from an ice in-feed device (120) onto an ice distribution device (120), where the feeding is controlled by a control unit using at least one characteristic parameter relating to the boxes including the width of the boxes as a control command, where the ice is distributed evenly by ice distribution device into the open upper side of the boxes while the boxes pass the ice distribution device,
wherein the method further comprises automatically adjusting the width of the distributed ice into the open upper side of the boxes based on the at least one characteristic parameter relating to the boxes such that the width of the distributed ice in the boxes is essentially the same as the width within the incoming boxes.

14. The method according to embodiment 12 or 13, wherein the weight of the distributed ice into the boxes is controlled based on the identified characteristics.

15. The method according to any of the embodiments 13 or 14, wherein the identified characteristics further include the length of the boxes, and/or the height of the boxes, and/or the available volume within the boxes.

Any of the above-mentioned embodiments 1-15 may be combined with any other embodiment or embodiments of the present application.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1.-15. (canceled)

16. A system for placing ice into boxes containing food products while the boxes are conveyed by a box conveyor device, where the boxes have an open upper side and two or more different widths extending across the conveying direction of the boxes, comprising:
a control unit,
an ice in-feed device,
an ice distribution device configured for receiving ice from the ice in-feed device and for distributing the received ice into the open upper side of the boxes while the boxes pass the ice distribution device,
wherein the ice distribution device further comprises an ice width adjuster device for interacting with the received ice prior to distributing the received ice into the open upper side of the boxes while the boxes pass the ice distribution device, where the ice width adjuster device is controlled by the control unit using at least one characteristic parameter relating to the boxes including the width of the boxes as a control command in adjusting the width of the width adjuster device such that the width of the distributed ice in the boxes is essentially the same as the width of the incoming boxes.

17. The system according to claim 16, wherein the ice distribution device comprises a conveyor device having an endless belt and position below the ice in-feed device and above the box-conveyor device, where the received ice is received on an upper side of the endless belt, where the control unit is further configured to operate the advancement of the endless belt of the conveyor device when distributing ice into the open upper side of the boxes.

18. The system according to claim 17, wherein the at least one characteristic parameter relating to the boxes further includes the length of the boxes, where the length is utilized by the control unit as a control parameter in controlling the advancing speed of the endless belt of the conveyor device while the boxes pass the ice distribution device, e.g. such that the speed is increased temporarily for shorter boxes compared to longer boxes.

19. The system according to claim 17, further comprising a front plate member placed in front of a downstream end of the conveyor device such that it extends below the upper side of the endless belt,
wherein the front plate member has an associated controllable bottom structure controlled by the control unit, where the controlling includes moving the associated bottom structure from a closing position where the front plate member and the bottom structure act as a buffer capable of accumulating ice therein from the downstream end of the conveyor device, to an open second position where the accumulated ice and ice from the downstream end of the conveyor device is released into the open upper side of the boxes as they pass the ice distribution device.

20. The system according to claim 16, wherein the ice in-feed device comprises an ice-portioning device configured to supply portions of ice to the ice distribution device.

21. The system according to claim 16, wherein the portions of ice are determined based on the at least one identified characteristic.

22. The system according to claim 20, wherein the ice-portioning device comprises at least one weighing hopper configured to receive and accumulate ice until a pre-defined target weight is accumulated, where the pre-defined target weight is dependent on the at least one characteristics of the incoming boxes.

23. The system according to claim 22, wherein the at least one weighing hopper includes two or more weighing hoppers, and where supplying portions of ice to the ice distribution device comprises releasing ice from one hopper at a time, or by two or more hoppers at a time.

24. The system according to claim 16, wherein the ice width adjuster device comprises adjustable guiding structures having downstream ends, and where adjusting the width includes adjusting the distance between the downstream ends of the guiding structure.

25. The system according to claim 16, wherein the adjustable guiding structures comprise a pair of adjustable flaps having free ends moveable relative to each other from a first position defining first width to at least one second position defining at least one second width, where the pair of flaps is positioned below a downstream end of the ice distribution device.

26. The system according to claim 16, wherein the ice in-feed device comprises:
an ice compartment having an open upper end for receiving ice from an ice source and an open lower end, and
an ice-infeed conveyor positioned below the lower end of the ice compartment having an infeed end and controlled by the control unit.

27. The system according to claim 16, further comprising a detection device for identifying at least one characteristic parameter relating to the boxes.

28. A method of automatically placing ice into boxes containing food products while the boxes are conveyed by a box conveyor device, where the boxes have an open upper side and two or more different widths extending across the conveying direction of the boxes, comprising:
feeding ice from an ice in-feed device onto an ice distribution device, where the feeding is controlled by a control unit using at least one characteristic parameter relating to the boxes including the width of the boxes as a control command, where the ice is distributed evenly by the ice distribution device into the open upper side of the boxes while the boxes pass the ice distribution device,
wherein the method further comprises automatically adjusting the width of the distributed ice into the open upper side of the boxes based on the at least one characteristic parameter relating to the boxes such that the width of the distributed ice in the boxes is essentially the same as the width of the incoming boxes.

29. The method according to claim 27, wherein the weight of the distributed ice into the boxes is controlled based on the identified characteristics.

30. The method according to claim 28, wherein the identified characteristics further include the length of the boxes, and/or the height of the boxes, and/or the available volume within the boxes.
